(19) United States
(12) Patent Application Publication
(10) Pub. No.: US 2007/0212629 A1
(43) Pub. Date: Sep. 13, 2007

(54) Toner and image forming apparatus

(76) Inventors: Naruo Yabe, Osaka-shi (JP); Kousuke Satou, Osaka-shi (JP)

Correspondence Address: CLARK & BRODY, 1090 VERMONT AVENUE, NW, SUITE 250, WASHINGTON, DC, 20005, US

(21) Appl. No.: 11/714,121

(22) Filed: Mar. 6, 2007

(30) Foreign Application Priority Data
Mar. 8, 2006 (JP) 2006-062361

(51) Int. Cl. G03G 9/08

(52) U.S. Cl. 430/108.6; 430/119.86; 430/119.71

(57) ABSTRACT

Disclosed is a toner for use in an image forming apparatus using an amorphous silicon photoconductor as a latent image carrier, and having a cleaning blade for removing the toner remaining on the photoconductor after a transfer step. The toner has a friction coefficient with the photoconductor in a range of 0.3 to 0.6. At least inorganic fine particles such as titanium oxide are externally added to the toner. The inorganic fine particles have a number-average primary particle size of 30 nm or more.

### BACKGROUND OF THE INVENTION

1. Field of the Invention

The present invention relates to a toner and an image forming apparatus, which are suitable for use in copying machines, printers, and facsimiles.

2. Description of Related Art

At the present time, organic photoconductors (OPC) are commonly employed as a photoconductor used in image forming apparatuses. As the durability of the image forming apparatuses increases, the apparatuses employing an amorphous silicon photoconductor are also put on the market. The reason for this is as follows. That is, the amorphous silicon photoconductor has extremely high durability because its film has extremely high hardness, leading to the life as long as 500,000 duplicates or more, whereas the life of the OPC is about 50,000 duplicates.

The image formation using the amorphous silicon photoconductor also follows the same process sequence of charging, exposure, development (reversal development), transfer, cleaning, and eraser, as in the case with the OPC. However, when the amorphous silicon photoconductor is used repetitively, due to the influence of discharge product generated in the charging step or the like, the resistance of the photoconductor surface is lowered under high-temperature and high humidity, and the phenomenon of so-called image flowing (“gazou nagare” in Japanese) is apt to occur. Therefore, the toner recovered by cleaning in the cleaning step is used to grind the photoconductor surface. In some cases, a paper powder component contained in a transfer paper attaches firmly to the photoconductor surface, causing an image defect there. On the other hand, when the grinding against the photoconductor surface is too strong, the photosensitive layer is excessively ground. If this is repeated for a long term, the photosensitive layer lacks thickness, resulting in poor image.

Consequently, in order to prevent the wear of the photoconductor surface, the method of defining the coefficient of the dynamic friction of toners has been proposed (for example, refer to Japanese Patent Unexamined Patent Publication No. 2004-258625). Although the developer having the appropriate coefficient of dynamic friction of the toner, which can be affected by a surface wax, is used to suppress uneven wear of the photoconductor, this coefficient of dynamic friction was found from measurements of samples of pellet-shaped toners, which may not always reflect the conditions within actual printers. Additionally, the long-term use of the photoconductor may raise the problem in its abrasiveness.

As described above, in the electrophotography process using the amorphous silicon photoconductor, it is unnecessary to replace the photoconductor before the machine life. This permits reductions in the number of members, manpower for member replacement, and downtime. This enables a suitable output process. It is however necessary to prevent toner compositions, paper powder, and discharge product, which can cause image defects, from attaching to the photoconductor surface. It is also necessary to perform suitable grinding under which the photoconductor is free from excessive film grinding.

### SUMMARY OF THE INVENTION

An advantage of the present invention is to provide a toner capable of attaining appropriate abrasiveness of an amorphous silicon photoconductor, and superior images without requiring replacement of the photoconductor before the machine life, by defining the friction coefficient between the photoconductor and the toner.

The present inventors have made tremendous research effort to solve the above-mentioned problems, and have discovered that the surface of a photoconductor can be maintained in its superior state over a long-term use, by employing a toner having a friction coefficient with an amorphous silicon photoconductor, which is within a predetermined range. The toner contains at least inorganic fine particles which are externally added and have a number-average primary particle size of 30 nm or more.

Specifically, in the toner used in an image forming apparatus employing an amorphous silicon photoconductor as a latent image carrier, and having a cleaning blade for removing toner remaining on the photoconductor after a transfer step, the friction coefficient with the photoconductor is 0.3 to 0.6, and at least inorganic fine particles having a number-average primary particle size of 30 nm or more are externally added.

In the toner, the toner having a particle size of not more than one-fourth of a volume reference mean particle size is preferably 30% or below in terms of number ratio. Preferably, the toner contains the inorganic fine particles in an amount of 0.5% or more. Preferably, the inorganic fine particles are titanium oxide particles having a number-average primary particle size of 50 nm or more.

The image forming apparatus of the present invention is one employing an amorphous silicon photoconductor as a latent image carrier, and having a cleaning blade for removing the toner remaining on the photoconductor after a transfer step, and uses the above toner.

Thus, the present invention is capable of attaining appropriate abrasiveness of the photoconductor, and maintaining the photoconductor surface causing neither the wear of a photosensitive layer nor image flowing, thereby forming superior images over a long term.

Other objects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating an image forming apparatus according to a preferred embodiment of the present invention; and

FIG. 2 is a schematic diagram illustrating an example of the apparatus for measuring friction coefficient in the present invention.

### DETAILED DESCRIPTION OF PREFERRED EMBODIMENTS

A toner and an image forming apparatus according to the present invention will be described below in detail.

The toner of the present invention is used in an image forming apparatus employing an amorphous silicon photoconductor as a latent image carrier, and having a cleaning blade for removing the toner remaining on the photoconductor after a transfer step.

In this image forming apparatus, it is necessary to suitably grind the surface of the photoconductor so as to be maintained in its superior state. In the grinding, the toner is press-contacted with the photoconductor by a cleaning blade or separately provided grinding means. At this time, adding inorganic fine particles to the toner can impart suitable abrasiveness. That is, the material of the inorganic fine particles added to the surface of the toner, its number-average primary particle size, and its adhesion state to the toner exert a large influence on the abrasiveness.

As inorganic fine particles useful for abrasiveness, there are metal oxides such as silica, titanium oxide, iron oxide, aluminium oxide, and strontium titanate. Among others, titanium oxide is effective in imparting abrasiveness. By externally adding the above inorganic fine particles to the toner, friction is generated between the toner and the photoconductor, and it can impart the appropriate abrasiveness. The friction coefficient between the toner of the present invention and the photoconductor is not less than 0.3 and not more than 0.6, as described above. When the friction coefficient is smaller than 0.3, the effect of grinding is insufficient. When it exceeds 0.6, the photoconductor is excessively ground, causing poor image.

The above abrasiveness depends on the number-average primary particle size of the inorganic fine particles added. In order to impart the appropriate abrasiveness, the number-average primary particle size is 20 nm or more, preferably 30 nm or more, more preferably 50 nm or more. The small inorganic fine particles having a number-average primary particle size of less than 20 nm may settle in the interior of the host particles of the toner due to the physical stress that the toner receives from a developing device and a cleaning part. As the result, the abrasiveness may be impaired. In the present invention, it is particularly necessary that inorganic fine particles having a number-average primary particle size of 30 nm or more be externally added.

The abrasiveness can be controlled by the amount of inorganic fine particles added to the toner. When the amount of the addition thereof is 0.1% or more to the amount of the toner, the appropriate abrasiveness can be obtained. It is preferably 0.3% or more, more preferably not less than 0.5% nor more than 2.0%. Below 0.3%, the effect of grinding is insufficient. Above 2.0%, the friction coefficient with the photoconductor is increased, and the photoconductor is excessively ground, causing poor image.

The abrasiveness can also be affected by toner fine powder contained in the toner. Here, the term “toner fine powder” means the toner fine powder having a particle size of not more than one-fourth of the volume reference mean particle size of the toner. The amount of the toner fine powder of the present invention is 30% or below in terms of number ratio (%). The toner fine powder contained in the toner tends to adhere to the surfaces of other toner particles. When the toner fine powder adhere to the surfaces of the toner particles and the amount of the toner fine powder exceeds 30%, the inorganic fine particles added for the purpose of grinding cannot directly contact with the photoconductor surface, and the abrasiveness is lowered. That is, a large amount of the toner fine powder makes impossible to attain sufficient grinding effect, even if added the appropriate inorganic fine particles. Further, image flowing may take place.

### <Manufacturing Method of Toner>

The toner used in the present invention can be manufactured in the following manner. That is, a release agent, a coloring agent and, a charge control agent are added to a predetermined amount of a binder resin, followed by stirring and mixing with a mixer such as a Henshel mixer. The mixture thus obtained is melt-kneaded with a biaxial extruder or the like, and then cooled, followed by grinding with a grinder such as a hammer mill or a jet mill. Subsequently, this is classified with a classifier such as a pneumatic classifier, resulting in the toner particles having a predetermined particle size. Next, a predetermined amount of the above-mentioned external additive is added to the obtained toner particles and then stirred and mixed with a mixer such as a Henshel mixer.

### <Binder Resin>

No particular limitations are imposed on a binder resin. There are, for example, thermoplastic resin such as styrene-acryl resin, polyester resin, polyacrylic resin, polyethylene resin, polypropylene resin, vinyl chloride resin, polyamide resin, polyurethane resin, polyvinyl alcohol resin, vinyl ether resin, N-vinyl resin, and styrene-butadiene resin. Of course, if necessary, other resin may be used together with the above resin. Alternatively, two or more types of these resins may be used together.

As the monomer that becomes the base substance of the above-mentioned styrene, there are, for example, styrene derivatives such as styrene-acryl resin, α-methylstyrene, p-methylstyrene, p-t-butylstyrene, p-chlorstyrene, and hydroxystyrene; and (meta) acrylic esters such as methacrylic acid, methyl(meta)acrylate, ethyl(meta)acrylate, propyl(meta)-acrylate, butyl(meta)acrylate, glycidyl(meta)acrylate, methoxyethyl(meta)acrylate, propoxyethyl(meta)acrylate, methoxydiethylene glycol(meta)acrylate, ethoxydiethylene glycol(meta)acrylate, benzil(meta)acrylate, cyclohexyl(meta)-acrylate, tetrahydrofurfuryl(meta)acrylate, (meta)-acrylonitrile, (meta)acrylamide, N-methylol(meta)acrylamide, ethylene glycol di(meta)acrylate, 1,3-butylene glycol di(meta)-acrylate, 1,4-butanedioldi(meta)acrylate, and trimethyl-ethanetri(meta)acrylate.

Each of the mixtures of various types of the above monomers can be polymerized by employing anyone of solution polymerization, bulk polymerization, emulsification polymerization, and suspension polymerization, thereby obtaining the binder resin used in the present invention. As the polymerization initiator used for the above polymerization, it is possible to use any known polymerization initiator such as acetyl peroxide, decanoyl peroxide, lauroyl peroxide, benzoyl peroxide, azobisisobutyronitrile, 2,2′-azobis-2,4-dimethylvalero-nitrile, or 2,2′-azobis-4-methoxy-2,4-dimethylvaleronitrile. Preferably, these polymerization initiators are used in the range of 0.1 to 15 weight % to the total weight of the monomer.

The above-mentioned polyester resin can be obtained mainly by condensation polymerization of polyvalent carboxylic acids and polyhydric alcohols. Examples of the polyvalent carboxylic acids are aromatic polyvalent carboxylic acids such as phthalic acid, isophthalic acid, terephthalic acid, succinic acid, 1,2,4-benzenetricarboxylic acid, 2,5,7-naphthalene-tricarboxylic acid, 1,2,4-naphthalenetricarboxylic acid, and pyromellitic acid; aliphatic dicarboxylic acids such as maleic acid, fumaric acid, succinic acid, adipic acid, sebacic acid, malonic acid, azelaic acid, mesaconic acid, citraconic acid, and glutaconic acid; alicyclic dicarboxylic acids such as cyclohexanedicarboxylic acid, and methylmedic acid; and anhydride of these carboxylic acids, and low alkyl esters. These can be used solely or in combination of two or more kinds.

The content of a trivalent or polyvalent composition depends on the degree of crosslinking. Its content may be adjusted to attain the desired degree of crosslinking. In general, the content of a trivalent or polyvalent composition is 15 mol % or below.

As polyhydric alcohols used in polyester resin, there are, for example, alkylene glycols such as ethylene glycol, 1,2-propylen glycol, 1,3-propylene glycol, 1,4-butanediol, 1,4-butenediol, neopentyl glycol, 1,5-pentane glycol, and 1,6-hexane glycol; alkylene ether glycols such as diethylene glycol, triethylene glycol, dipropylene glycol, polyethylene glycol, polypropylene glycol, and polytetramethylene glycol; alicyclic polyhydric alcohols such as 1-4-cyclohexanedimethanol, and hydrogenated bisphenol A; bisphenols such as bisphenol A, bisphenol F, and bisphenol S; and alkyleneoxide addition products of bisphenols. These can be used solely or in combination of two or more kinds.

For the purposes of adjusting molecular weight and controlling reaction, monocarboxylic acid or monoalcohol may be used as needed. Examples of monocarboxylic acid are benzoic acid, paraoxy benzoic acid, toluene carboxylic acid, salicylic acid, acetic acid, propionic acid, and stearic acid. Examples of monoalcohol are benzyl alcohol, toluene-4-methanol, and cyclohexane methanol.

The glass transition temperature of the binder resin is preferably in the range of 54 to 62° C. When it is below 54° C., the binder resin might solidify in a developing device or a toner cartridge. When it is above 62° C., the toner may not fix sufficiently to a transfer material such as paper.

### <Release Agent>

As a release agent, various types of waxes or low-molecular weight olefin resins can be used. Examples of the waxes are polyhydric alcohol ester of fatty acid, higher alcohol ester of fatty acid, alkylenebis fatty acid amide compound, and natural wax. Examples of the low-molecular weight olefin resin are polypropylene, polyethylene, and propylene-ethylene copolymer, each having a number-average molecular weight of 1,000 to 10,000, especially 2,000 to 6,000. The content of the release agent is preferably 0.1 to 20 weight parts to 100 weight parts of the binder resin.

### <Coloring Agent>

In a magnetic toner, the toner color becomes black due to magnetic powder. Therefore, when used as a black toner, it is generally unnecessary to use any coloring agent. However, for coloring reinforcement, carbon black such as acetylene black, run black, or aniline black may be dispersed and mixed in the toner particles. Also in this case, the content of the coloring agent is preferably 0.1 to 10 weight parts to 100 weight parts of the binder resin.

### <Charge Control Agent>

As a charge control agent, any known charge control agent can be used. Examples of positive-charging charge control agent are nigrosine dye, fatty acid denatured nigrosine dye, fatty acid denatured nigrosine dye containing carboxyl group, quaternary ammonium salt, amine compound, and organic metal compound. Examples of negative-charging charge control agent are metal complex of oxycarboxylic acid, metal complex of azo compound, metallic complex dye, and salicylic acid derivative. The content of the charge control agent is preferably 0.1 to 10 weight parts to 100 weight parts of the binder resin.

### <Magnetic Powder>

Examples of magnetic powder are triiron tetraoxide (Fe₃O₄), triiron dioxide (γ-Fe₂O₃), iron oxide zinc (ZnFe₃O₄), iron oxide yttrium (Y₃Fe₃O₁₂), iron oxide cadmium (CdFe₂O₄), iron oxide gadolinium (Gd₃Fe₅O₁₂), iron oxide copper (CuFe₂O₄), iron oxide lead (PbFe₁₂° ₁₉), iron oxide nickel (NiFe₂O₄), iron oxide neodymium (NdFeO₃), iron oxide barium (BaFe₁₂O₁₉), iron oxide magnesium (MgFe₂O₄), iron oxide manganese (MnFe₂O₄), iron oxide lantern (LaFeO₃), iron powder (Fe), cobalt power (Co), and nickel powder (Ni). Among others, triiron tetraoxide (magnetite) in the shape of fine particles is preferred. Suitable magnetite is in the shape of regular octahedron and has a particle size of 0.05 to 1.0 μm. These magnetite particles may be surface treated with silane coupling agent, titanium coupling agent, or the like.

The content of the magnetic powder is 35 to 160 weight parts, preferably 55 to 140 weight parts, to 100 weight parts of the binder resin.

### <External Additive>

In order to adjust the charge control property and the flowability of the toner, in addition to silica and titanium oxide as described above, it is possible to use, as an external additive, inorganic fine powder of alumina, zinc oxide, magnesium oxide, or calcium carbonate; organic fine powder such as polymethyl methacrylate; fatty acid metal salt such as zinc stearate. These can be used solely or in combination of two or more kinds. The content of the external additive is preferably 0.1 to 2.0 weight % per toner particle. The external additive and the toner particles can be mixed by a Henshel mixer, a V-type mixer, a Turbular mixer, or a Hybritizer.

The inorganic fine powder may be not surface treated. Alternatively, if necessary, it may be surface treated so as to be hydrophobic and for charge control, by using silane coupling agent, aminosilane, silicone oil, or titanate coupling agent.

Examples of the silane coupling agent are organoalkoxy silane (e.g. methoxytrimethyl silane, dimethoxydimethyl silane, trimethoxymethyl silane, and ethoxytrimethyl silane); organochlor silane (e.g. trichlormethyl silane, dichlordimethyl silane, chlortrimethyl silane, trichlorethyl silane, dichlordiethyl silane, chlortriethyl silane, and trichlorphenyl silane); organo silazane (e.g. triethyl silazane, tripropyl silazane, and triphenyl silazane); organodi silazane (e.g. hexamethyldi silazane, hexaethyldi silazane, and hexaphenyldi silazane); and other organo silanes. These may be used solely or in combination of two or more kinds. Among others, organochlor silane, organo silazane, and organodi silazane are preferred.

Examples of the silicone oil are dimethyl silicone oil, methylphenyl silicone oil, methylhydrogen silicone oil, fluoro silicone oil, and denatured silicone oil. These may be used solely or in combination of two or more kinds. If necessary, the above silicone oil may be cured by a crosslinking agent and heat treatment. Among others, dimethyl silicone oil can be used suitably.

Examples of the titanate coupling agent are isopropyltriisostearoil titanate, isopropyltriclumilphyenyl titanate, and tetraisopropylbis(dioctylphosphite)titanate. These may be used solely or in combination of two or more kinds. Among others, isopropyltriisostearoil titanate is preferred.

The content of the coupling agent is preferably 0.05 to 20 weight parts to 100 weight parts of the external additive.

### <Photoconductor>

As a photoconductor, a photoconductor of amorphous silicon (a-Si) is used.

As an amorphous silicon photoconductor, it is possible to use any one of known photoconductors having different structures, which are provided with an amorphous silicon photosensitive layer on a conductive substrate formed in a predetermined shape such as a drum-shape.

The amorphous silicon photosensitive layer can be formed by, for example, vapor phase epitaxy method such as glow discharge decomposition method, sputtering method, ECR method, or deposition method. At the time of the formation thereof, H and halogen element can also be contained.

In order to adjust the characteristic of the photoconductor, the element such as C, N, O, or the like may be contained, or the element of the group XIII or the element of the group XV in the periodic table (the long period type) may be contained.

Specifically, the photosensitive layer is preferably formed of various materials having photoconductivity, for example, amorphous silicon such as a-SiC, a-SiO, or a-SiON, besides a-Si.

Most preferred is a-SiC. When using this, the value x in Si₁₋ₓCₓ is set to 0<x≦0.5, preferably 0.05≦x≦0.45.

Within this range, the photosensitivity characteristic of the photoconductor can be improved by increasing the resistance of an a-SiC layer than an a-Si layer, while maintaining superior carrier transportation.

In the element of the group XIII and the element of the group XV, B and P, respectively, are preferred because these have excellent covalent bonding property, so that semiconductor characteristics can be changed sensitively, and excellent photosensitivity can be obtained. Further, both of the photosensitivity and withstand voltage characteristics of the photoconductor can be increased by employing the amorphous silicon photosensitive layer where a layer region with the increased optical carrier formation function (an optical excitation layer region), and a layer region with the carrier transportation function (a carrier transportation layer region) are stacked one upon another.

At this time, in order to increase the efficiency of optical carrier formation, the optical excitation layer region is preferably formed by taking care of the following points in the film formation conditions: (i) the film forming speed is set to a relatively low; (ii) the dilution ratio of the film formation components with H₂ and He is increased; and (iii) the amount of the element to be doped is increased than that in the carrier transportation layer region.

The carrier transportation layer region functions mainly to increase the withstand voltage of the photosensitive layer and smoothly transport the carriers infused from the optical excitation layer region to the conductive substrate. The carrier transportation layer region also contributes to the improvement in the photosensitivity of the photoconductor, because in this layer region, carriers can be formed with the light passing through the optical excitation layer region.

The thickness of the amorphous silicon photosensitive layer is preferably a value obtained by adding 0.1 to 2.0 μm to the depth of optical absorption, which can be found from the optical absorption coefficient of this photosensitive layer with respect to the light of exposure wavelength.

In the case where the photosensitive layer is composed of the optical excitation layer region and the carrier transportation layer region which are stacked one upon another as described above, the thickness of the optical excitation layer region is preferably set to be substantially the same as the depth of the above-mentioned depth of optical absorption.

Preferably, a carrier blocking layer is interposed between the photosensitive layer and the conductive substrate. When the surface of the photoconductor contacts with the toner under bias voltage during the time of development, the carrier blocking layer functions to block the infusion of carriers from the conductive substrate to the photosensitive layer. This enables the electrostatic contrast between an exposure part and a non-exposure part to be increased, thereby improving the image density and also reducing the fog at a blank space. As the carrier blocking layer, it is preferable to use an inorganic insulating layer formed of a-SiC, a-SiO, a-SiN, a-SiON, or a-SiCON, each having insulating property, or an organic insulating layer formed of polyethylene terephthalate, parylene (registered trademark), polytetrafluoroethylene, polyimide, polyethylenepropylene fluoride, polyurethane, epoxy resin, polyester, polycarbonate, cellulose acetate resin, or the like.

The carrier blocking layer is also required to have, in addition to insulating property, the characteristic of superior adhesion with the conductive substrate and the amorphous silicon photosensitive layer, and the characteristic of causing no large decomposition due to heating and the like when forming the photosensitive layer. In consideration of these characteristics, the carrier blocking layer is also preferably formed of a-SiC. In order to impart insulating property to the a-SiC for forming the carrier blocking layer, the amount of C to be contained in the carrier blocking layer may be larger than that of the photosensitive layer.

The thickness of the carrier blocking layer is preferably 0.01 to 5 μm, more preferably 0.1 to 3 μm. It is preferable to protect the surface of the photosensitive layer by coating it with a surface protection layer composed of an organic or inorganic insulating material. This can prevent that, when discharging with charging means and the like, the surface of the photosensitive layer is oxidized to form an oxide film that is apt to absorb ion product and water molecules. This can also improve withstand voltage, and wear resistance during repetitive uses.

As the surface protection layer, it is particularly preferable to use the layer of an insulating material of a-Si such as a-SiC, a-SiN, a-SiO, a-SiCO, a-SiNO. Among others, a-SiC is preferred. These can be formed in the same thin film forming method as in the photosensitive layer.

When a-SiC is used in the surface protection layer, in order to impart insulating property thereto, the content of C may be larger than that of the photosensitive layer, as in the case with the carrier blocking layer.

Specifically, the value x in Si₁₋ₓCₓ is preferably set to 0.3≦x≦1.0, especially 0.5≦x≦0.95. It is also preferable that the above value x of C be adjusted to attain 10¹³Ω·cm or more in the dark resistibility of the surface protection layer. When the dark resistibility is 10¹³Ω·cm or more, due to less flow of the potential in a plane direction of the surface protection layer, the photoconductor has high capability of maintaining an electrostatic latent image and excellent moisture resistance. The photoconductor will thus have excellent property of suppressing the occurrence of image flowing due to moisture.

Further, this surface protection layer of high resistance also functions to block the charge infusion through the toner due to the bias, and increase the potential contrast between the exposure part and the non-exposure part so as to attract more toner on the surface of the surface protection layer, so that the toner image density can be increased thereby to sufficiently increase the image density. This surface protection layer can also suppress the fog at the blank space, and enhance the withstand voltage of the photoconductor.

The surface protection layer formed with an insulating material other than a-SiC has the fear that the optical carriers will continuously be trapped even after the image formation, and hence the residual potential cannot be eliminated surely in the normal eraser.

On the other hand, the surface protection layer formed with a-SiC has the following characteristics that it can effectively block the positive charge infusion from the surface thereof, the negative charge from the conductive substrate can pass through this layer relatively easily. Hence, this surface protection layer has the advantage that the residual potential after the image formation can be eliminated effectively by the normal eraser, enabling the image information to be performed continuously.

The surface protection layer formed with a-SiC also has the advantage that a stable image formation can be performed over a long period of time, because it has excellent adhesion with the photosensitive layer of amorphous silicon such as a-SiC, as well as excellent wear resistance and environmental resistance.

In an alternative, the surface protection layer formed with a-SiC may have, within its own layer, a gradient of the C content in the thickness direction. In another alternative, it may contain the elements such as N, O, and Ge, together with C, in order to further increase moisture resistance.

The thickness of the surface protection layer is preferably 0.05 to 5 μm, more preferably 0.1 to 3 μm. Below 0.05 μm, there is the fear that the effect of preventing the oxide film formation, the effect of improving withstand voltage, or the effect of improving the wear resistance during repetitive uses, as described above, cannot be attained sufficiently. There is also the fear that the optical carriers cannot be trapped effectively, failing to contribute to the toner image formation.

On the other hand, when the thickness of the surface protection layer exceeds 5 μm, there is the fear that, when forming a fine charge pattern, the electric field (electric lines of force) will expand in the film surface direction in the surface protection layer, and resolving power will be lowered, failing to attain sufficient resolution.

There is also the fear that the charge remaining in the surface will be increased to raise the residual potential, causing the problems such as a drop in image density, the fog at the blank space, or variations in image density during the repetitive uses.

### <Image Forming Apparatus>

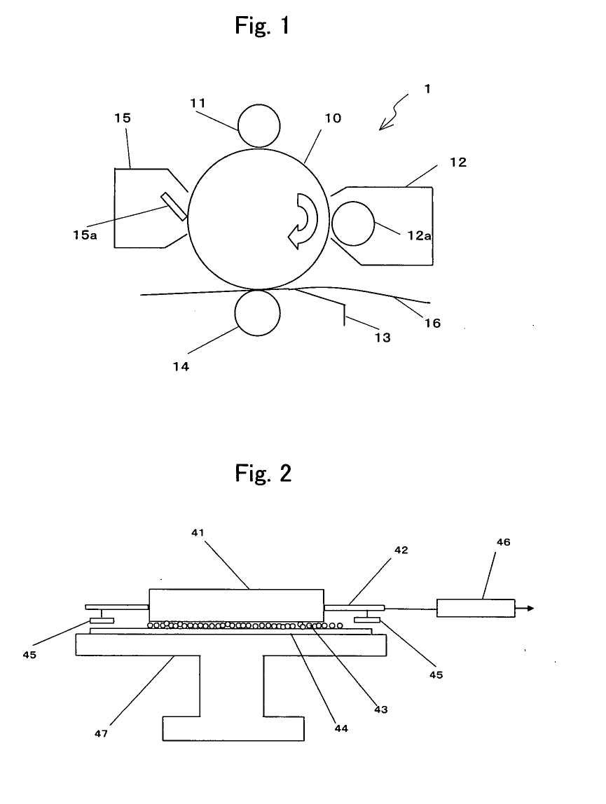

An image forming apparatus according to a preferred embodiment of the present invention will be described with reference to the accompanying drawings. FIG. 1 illustrates the schematic construction of an image forming apparatus 1 according to the present embodiment. The image forming apparatus 1 is provided with the following components:

(i) a latent image carrier drum 10 with an amorphous silicon drum;

(ii) a charge roller 11 as a contact charging member that applies a charge voltage by making a contact with the surface of the latent image carrier drum 10;

(iii) exposure means (not shown) that forms an electrostatic latent image by exposing the surface of the latent image carrier drum 10;

(iv) developing means 12 such as a developing sleeve 12a that forms a toner image by allowing a charging toner of a predetermined polarity to adhere to an electrostatic latent image on the latent image carrier drum 10;

(v) a transfer member 14 such as a contact transfer roller that applies a transfer voltage to a transfer material 16 such as paper conveyed by conveying means 13, thereby transferring the toner image on the latent image carrier drum 10 to the transfer material 16; and

(vi) a latent image carrier cleaning means 15 (a cleaning blade 15a) that recovers non-transferred toner remaining on the latent image carrier drum 10.

During the time of image formation, the latent image carrier drum 10 is uniformly charged by the contact charging member 11, and laser beams or the like is irradiated from an exposure device to the surface of the latent image carrier drum 10, thereby forming an electrostatic latent image. That is, the potential of a light irradiating part is lowered to form the electrostatic latent image.

The developing means 12 is provided with the rotatable developing sleeve 12a disposed oppositely to the latent image carrier drum 10. The developing means 12 develops (visualizes), as a toner image, a developer (toner) carried on the surface of the developing sleeve 12a by allowing it to adhere to the electrostatic latent image on the surface of the latent image carrier drum 10. That is, the developer within the developing means 12 is stirred by a stirring member, and subjected to frictional electrification so as to be the same polarity as the charging polarity of the latent image carrier drum 10, and then conveyed toward the developing sleeve 12a. The developing sleeve 12a is arranged with a predetermined gap to the latent image carrier drum 10, and the developer on the surface of the developing sleeve 12a can be formed in a predetermined layer thickness under the layer thickness regulation of a regulating blade. By applying a developing bias to the developing sleeve 12a, the charging toner can be adhered to a location where the potential is lowered by the above-mentioned image exposure, enabling a toner image to be formed on the surface of the latent image carrier drum 10. Subsequently, the contact transfer roller 14 applies a transfer voltage to the conveyed transfer material 16, so that the toner image on the latent image carrier drum 10 can be transferred to the transfer material 16. The remaining toner on the latent image carrier drum 10 is then removed and recovered by the cleaning blade 15a.

The present invention will next be described in further detail by referring to examples and comparative examples, which are shown by way of example and without limitation.

### EXAMPLES

### Example 1

### (Manufacturing of Toner)

A 50 mass parts of styrene acrylic copolymer as a binder resin, 50 mass parts of magnetic powder (magnetite, manufactured by TODA KOGYO CORP.), 2 mass parts of quaternary ammonium salt (“Bontron P-51,” manufactured by Orient Chemical Kabushiki Kaisha) as a positive charge control agent, and 5 mass parts of polypropyrene wax as an offset inhibitor were mixed by a Henshel mixer. The mixture was then melt and kneaded by a biaxial extruder, and cooled by a drum flaker. This was roughly ground by a hammer mill and then finely ground by a turbo mill. Subsequently, this was classified by a pneumatic classifier, thereby obtaining toner particles. The volume reference mean particle size of the toner particles and the content of fine powder were adjusted by the operating conditions in the grinding step and the classification step. For example, the toner containing the desired amount of fine powder (in terms of number ratio) could attain the desired particle size by appropriately adjusting the manufacturing conditions of the grinding and classification.

To the toner powder obtained above, titanium oxide which was surface treated with isopropyltriisostearoil titanate as a titanate coupling agent (rutile type, manufactured by Ishihara Sangyo Kaisha, Ltd.), and silica 1 which was surface treated with aminosilane and further with silicone oil were added and stirred by a Henshel mixer for two minutes so that titanium oxide and silica could be adhered to the surface of the above toner powder, resulting in the toner.

### Examples 2 to 7 and Comparative Examples 1 to 4

The toners were manufactured in the same manner as in Example 1, except for employing the combinations as shown in Table 1. Silica 2 used in Example 6 was manufactured by Nippon Aerosil Co., Ltd.)

### <Measurement of Toner Particle Size>

The volume reference mean particle size (diameter) of the toner particles was measured as follows. With a “Multisizer 3” (product name) being a Coulter counter manufactured by Beckman Coulter, Inc., the particle size distribution of the toner particles was measured by using an aperture of 100 μm. The mean particle size of the toner particles was found from the volume reference particle size distribution of the toner.

### <Measurement of Fine Powder Content>

The content of the fine powder in the toner was found in the following manner. That is, the sampled toner particles of a predetermined amount were analyzed with a flow particle image analyzer “FPIA-2100” (manufactured by Sysmex Corp.). The total number of the measured particles and the number of particles of not more than one-fourth of the volume reference mean particle size were counted to find the content of the fine powder (%).

### <Measurement of Particle Size of Inorganic Fine Particles>

The number-average primary particle sizes (diameters) of titanium oxide and silica were measured as follows. The photographs of the surfaces of the toner particles were taken which were magnified 30,000 times by a scanning electron microscope (SEM) (“JSM-880” manufactured by JEOL Ltd.). With an image analyzer (“Macview,” manufactured by MAUNTECH Co., Ltd.), the particle sizes of arbitrary 100 particles in the titanium oxide and those in the silica were measured, and the number-average primary particle sizes thereof were found by arithmetic mean.

### <Measurement of Friction Coefficient>

The friction coefficient between the photoconductor drum and the toner was measured by the method as shown in FIG. 2. Firstly, a wrapping paper was put on a flat plate 47, and a double sided tape 44 for fixing a toner 43 was stuck to the wrapping paper. The toner 43 containing titanium oxide and silica as external additives was put and coated on the double-sided tape 44, and air was blown against the layer of the toner 43 so as to be uniform and in its further monolayer state.

Subsequently, a photoconductor drum tube 41 was put on the surface of the toner 43 coated over the double-sided tape 44, and pulled at a constant speed with a spring balance 46 hung on one end of a shaft 42 of the tube 41. The frictional force was determined by reading the values of the spring balance 46. The pull speed of the spring balance 46 was 0.1 to 0.3 m/sec. A weight 45 was suspended from both ends of the shaft 42 of the photoconductor drum tube 41. The frictional force was determined every time a load was applied by increasing the weight 45.

The weight 45 was changed in the range of 200 g to 500 g, and the obtained results were averaged to find a friction coefficient.

### <Evaluation Tests of Image Characteristics>

With respect to the toners manufactured in Examples 1 to 7 and Comparative Examples 1 to 4 as shown in Table 1, the evaluation tests of image characteristics at a first stage, a second stage of after 100,000 duplicates, and a third stage of after 300,000 duplicates were conducted by using a printer (Model FS-1920) manufactured by KYOCERA MITA Corp., equipped with the amorphous silicon photoconductor drum as described above.

Specifically, the evaluation at the initial stage employed the image immediately after installing the toner, and the evaluations at the second and third stages employed the images after an ISO-4% copy was continuously copied to obtain 100,000 duplicates and 300,000 duplicates, respectively.

The evaluation results are shown in Table 1.

TABLE 1

| | Toner Particle | | Silica 1 | | Titanium Oxide | | Silica 2 | | |
|---|---|---|---|---|---|---|---|---|---|
| | Particle | Fine Powder | Particle | Additive | Particle | Additive | Particle | Additive | |
| | Size¹⁾ | Content | Size²⁾ | Amount | Size²⁾ | Amount | Size²⁾ | Amount | Friction |
| | (μm) | (Number %) | (nm) | (mass %) | (nm) | (mass %) | (nm) | (mass %) | Coefficient |
| Example 1 | 7.8 | 12 | 20 | 0.7 | 50 | 0.8 | — | — | 0.400 |
| Example 2 | 7.8 | 12 | 20 | 0.7 | 50 | 0.5 | — | — | 0.350 |
| Example 3 | 7.8 | 12 | 20 | 0.7 | 250 | 1.2 | — | — | 0.580 |
| Example 4 | 7.9 | 23 | 20 | 0.7 | 50 | 0.8 | — | — | 0.380 |
| Example 5 | 7.8 | 28 | 20 | 0.7 | 50 | 0.8 | — | — | 0.410 |
| Example 6 | 7.8 | 12 | 20 | 0.7 | — | — | 30 | 1 | 0.32 |
| Example 7 | 7.6 | 32 | 20 | 0.7 | 50 | 0.8 | — | — | 0.31 |
| Comp. | 7.8 | 12 | 20 | 0.5 | 15 | 0.8 | — | — | 0.430 |
| Example 1 | | | | | | | | | |
| Comp. | 7.8 | 12 | 20 | 0.5 | 30 | 0.3 | — | — | 0.280 |
| Example 2 | | | | | | | | | |
| Comp. | 7.8 | 12 | 30 | 1.2 | 250 | 1.8 | — | — | 0.630 |
| Example 3 | | | | | | | | | |
| Comp. | 7.8 | 12 | 20 | 1.7 | — | — | — | — | 0.24 |
| Example 4 | | | | | | | | | |

¹⁾Volume reference mean particle size
²⁾Number average particle size

The images were evaluated in terms of the characteristics of image density, fog, and image flowing. The evaluation methods and the evaluation criteria were as follows.

With respect to image density (ID), full-color solid images were measured and evaluated by using a Macbeth reflection densitometer (Model RD914). In the evaluation criteria, the ID of 1.30 or more was expressed by the symbol “0”; the ID of not less than 1.2 and less than 1.3 was expressed by the symbol “Δ”; and the ID of less than 1.2 was expressed by the symbol “x”.

The fog density (FD) was measured and evaluated by using a reflection densitometer (“TC-6D,” manufactured by Tokyo Denshoku Co., Ltd.). In the evaluation criteria, the FD of 0.010 or below was expressed by the symbol “∘”; the FD of not less than 0.011 and less than 0.020 was expressed by the symbol “Δ”; and the FD of 0.020 or more was expressed by the symbol “x”.

The image flowing was determined by visual observation. In the evaluation criteria, no image flowing was expressed by the symbol “∘”; the case where the image content was recognizable in the presence of image flowing was expressed by the symbol “Δ”; and the case where the image flowing made impossible to recognize the image content was indicated by the symbol “x”.

The evaluation results are shown in Table 2.

TABLE 2

| | Image Density | | | Fog Density | | | Image Flowing | | |
|---|---|---|---|---|---|---|---|---|---|
| | | After | After | | After | After | | After | After |
| | Initial | 100,000 | 200,000 | Initial | 100,000 | 200,000 | Initial | 100,000 | 200,000 |
| Example 1 | ◯ | ◯ | ◯ | ◯ | ◯ | ◯ | ◯ | ◯ | ◯ |
| Example 2 | ◯ | ◯ | ◯ | ◯ | ◯ | ◯ | ◯ | ◯ | Δ |
| Example 3 | ◯ | ◯ | Δ | ◯ | ◯ | ◯ | ◯ | ◯ | ◯ |
| Example 4 | ◯ | ◯ | ◯ | ◯ | ◯ | ◯ | ◯ | ◯ | Δ |
| Example 5 | ◯ | ◯ | ◯ | ◯ | ◯ | Δ | ◯ | ◯ | Δ |
| Example 6 | ◯ | ◯ | ◯ | ◯ | ◯ | ◯ | ◯ | ◯ | ◯ |
| Example 7 | ◯ | ◯ | Δ | ◯ | ◯ | Δ | ◯ | Δ | X |
| Comp. | ◯ | ◯ | E.D. | ◯ | X | E.D. | ◯ | ◯ | E.D. |
| Example 1 | | | | | | | | | |
| Comp. | ◯ | ◯ | E.D. | ◯ | X | E.D. | ◯ | ◯ | E.D. |
| Example 2 | | | | | | | | | |
| Comp. | ◯ | Δ | X | ◯ | Δ | X | ◯ | ◯ | ◯ |
| Example 3 | | | | | | | | | |
| Comp. | ◯ | ◯ | Δ | ◯ | Δ | X | ◯ | X | X |
| Example 4 | | | | | | | | | |

“E.D.” means that evaluation was discontinued.

As shown in Table 2, Comparative Example 1 and Comparative Example 2 were beyond the range of the present invention in terms of the number-average primary particle size of titanium oxide, and the friction coefficient, respectively. Hence, both lacked in the grinding force of the photoconductor and had poor image characteristics before printing 200,000 papers, and then the evaluation was discontinued. Comparative Example 3 was beyond the range of the present invention in terms of the content of titanium oxide and friction coefficient. Therefore, the image density and the fog density were poor after printing 200,000 papers, and the photoconductor was ground.

In contrast, it was confirmed that Examples 1 to 7, within the range of the present invention, particularly Examples 1 to 6 were capable of forming excellent images even after printing 200,000 papers, as well as at the initial stage and after printing 100,000 papers. Specifically, they maintained excellent image density with little or no fog, and the image flowing was tolerable levels in the practical use.

What is claimed is:

1. A toner for use in an image forming apparatus employing an amorphous silicon photoconductor as a latent image carrier, and having a cleaning blade for removing toner remaining on the photoconductor after a transfer step, wherein the toner has a friction coefficient with the photoconductor in a range of 0.3 to 0.6, and at least inorganic fine particles having a number-average primary particle size of 30 nm or more is externally added.

2. The toner according to claim 1, containing toner particles having a particle size of not more than one-fourth of a volume reference mean particle size, in an amount of 30% or below in terms of number ratio.

3. The toner according to claim 1, containing the inorganic fine particles in an amount of 0.5% or more.

4. The toner according to claim 1, wherein the inorganic fine particles are titanium oxide particles having a number-average primary particle size of 50 nm or more.

5. The toner according to claim 1, containing titanium oxide as the inorganic fine particles.

6. The toner according to claim 1, wherein the inorganic fine particles are surface-treated particles.

7. An image forming apparatus using an amorphous silicon photoconductor as a latent image carrier, and having a cleaning blade for removing toner remaining on the photoconductor after a transfer step, wherein the image forming apparatus uses the toner as set forth in claim 1.

8. The image forming apparatus according to claim 7, comprising:
an amorphous silicon photoconductor;
a charge roller for applying a charge voltage by contacting with a surface of the photoconductor;
light-exposure means for forming an electrostatic latent image by exposing the surface of the photoconductor;
development means for forming a toner image by allowing a charging toner of a predetermined polarity to adhere to the electrostatic latent image on the photoconductor;
a transfer member for transferring the toner image on the photoconductor to a transfer material by applying a transfer voltage to the transfer material; and
a cleaning blade for recovering non-transferred toner remaining on the photoconductor.
